(19) United States
(12) Patent Application Publication
(10) Pub. No.: US 2024/0365152 A1
(43) Pub. Date: Oct. 31, 2024

(54) RIS CONFIGURATION COMPUTATION USING REINFORCEMENT LEARNING

(71) Applicant: QUALCOMM Incorporated, San Diego, CA (US)

(72) Inventors: Ahmed ELSHAFIE, San Diego, CA (US); Hung Dinh LY, San Diego, CA (US); Yu ZHANG, San Diego, CA (US)

(21) Appl. No.: 18/684,166

(22) PCT Filed: Oct. 27, 2021
(86) PCT No.: PCT/CN2021/126658

§ 371 Date: Feb. 15, 2024

(51) Int. Cl. H04W 24/10; H04B 7/04

(52) U.S. Cl. CPC H04W 24/10; H04B 7/04013

(57) ABSTRACT

Methods, apparatuses, and computer-readable medium for configuring a reconfigurable intelligent surface (RIS) are provided. An example method may include receiving, from a second wireless device through a RIS, a set of reference signals (RSs) mapped to a set of single port resources, the set of single port resources being quasi-co-located (QCLed) and time division multiplexed (TDMed). The example method may further include transmitting, to the second wireless device through the RIS, a set of measurement results based on the set of RSs, the set of measurement results being mapped to a set of surface configurations of the RIS.

### TECHNICAL FIELD

The present disclosure relates generally to communication systems, and more particularly, to wireless communication systems with a reconfigurable intelligent surface (RIS).

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first wireless device are provided. The first wireless device may be a user equipment (UE). The apparatus may include a memory and at least one processor coupled to the memory. The memory and the at least one processor coupled to the memory may be configured to receive, from a second wireless device through a reconfigurable intelligent surface (RIS), a set of reference signals (RSs) mapped to a set of single port resources, the set of single port resources being quasi-co-located (QCLed) and time division multiplexed (TDMed). The memory and the at least one processor coupled to the memory may be further configured to transmit, to the second wireless device through the RIS, a set of measurement results based on the set of RSs, the set of measurement results being mapped to a set of surface configurations of the RIS.

In another aspect of the disclosure, a method, a computer-readable medium, and an apparatus at a first wireless device are provided. The first wireless device may be a base station or a UE. The apparatus may include a memory and at least one processor coupled to the memory. The memory and the at least one processor coupled to the memory may be configured to transmit, to a second wireless device through a RIS, a set of RSs mapped to a set of single port resources, the set of single port resources being QCLed and TDMed. The memory and the at least one processor coupled to the memory may be further configured to receive, from the second wireless device through the RIS, a set of measurement results based on the set of RSs, the set of measurement results being mapped to a set of surface configurations of the RIS.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating example RIS.

FIGS. 5A and 5B illustrate communications between UEs and base station(s) with and without RIS.

FIG. 6 is a diagram illustrating an example communication flow between a base station, UEs, and a RIS.

FIG. 7A is a diagram illustrating an example Markov decision process (MDP).

FIG. 7B is diagram illustrating an example state transition.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an example apparatus.

FIG. 13 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

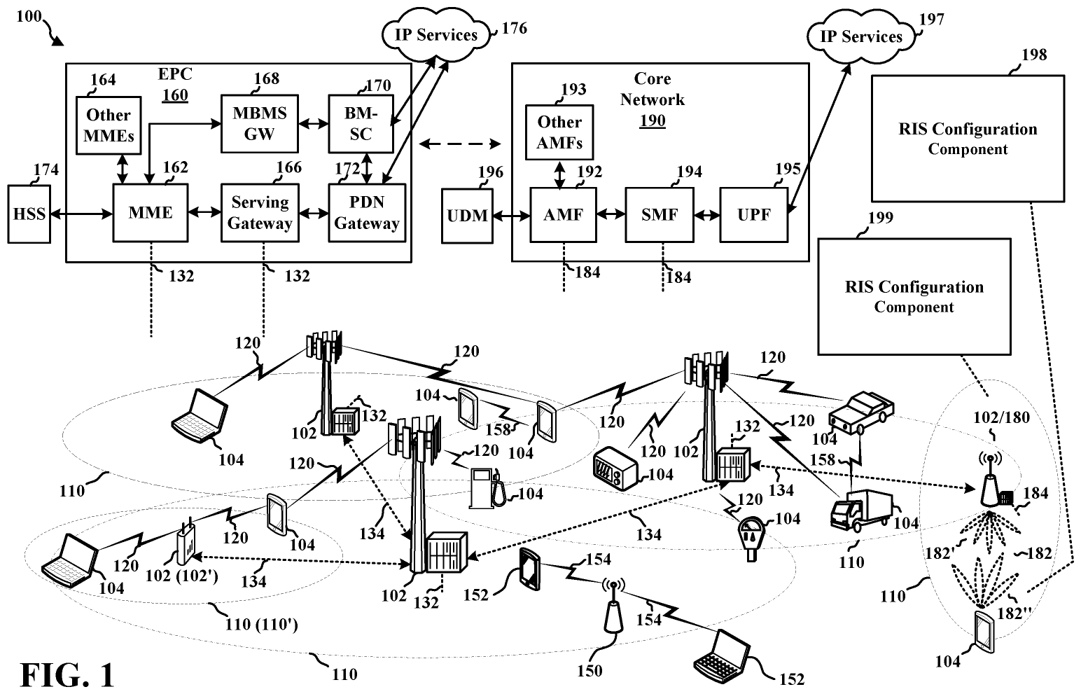

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FRI (410 MHZ-7.125 GHZ) and FR2 (24.25 GHz-52.6 GHZ). Although a portion of FRI is greater than 6 GHz, FR1is often referred to (interchangeably) as a “sub-6 GHz” band in various documents and articles. A similar nomenclature issue sometimes occurs with regard to FR2,which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FRI characteristics and/or FR2characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (52.6 GHZ-114.25 GHZ), and FR5 (114.25 GHZ-300 GHZ). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FRI, or may include mid-band frequencies. Further, unless specifically stated otherwise, it should be understood that the term “millimeter wave” or the like if used herein may broadly represent frequencies that may include mid-band frequencies, may be within FR2,FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, cNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a RIS configuration component 198. In some aspects, the RIS configuration component 198 may be configured to receive, from a second wireless device through a RIS, a set of RSs mapped to a set of single port resources, the set of single port resources being QCLed and TDMed. In some aspects, the RIS configuration component 198 may be further configured to transmit, to the second wireless device through the RIS, a set of measurement results based on the set of RSs, the set of measurement results being mapped to a set of surface configurations of the RIS.

In certain aspects, the base station 180 may include a RIS configuration component 199. In some aspects, the RIS configuration component 199 may be configured to transmit, to a second wireless device through a RIS, a set of RSs mapped to a set of single port resources, the set of single port resources being QCLed and TDMed. In some aspects, the RIS configuration component 199 may be further configured to receive, from the second wireless device through the RIS, a set of measurement results based on the set of RSs, the set of measurement results being mapped to a set of surface configurations of the RIS.

Although the following description may be focused on 5G NR, the concepts described herein may be applicable to other similar areas, such as LTE, LTE-A, CDMA, GSM, and other wireless technologies.

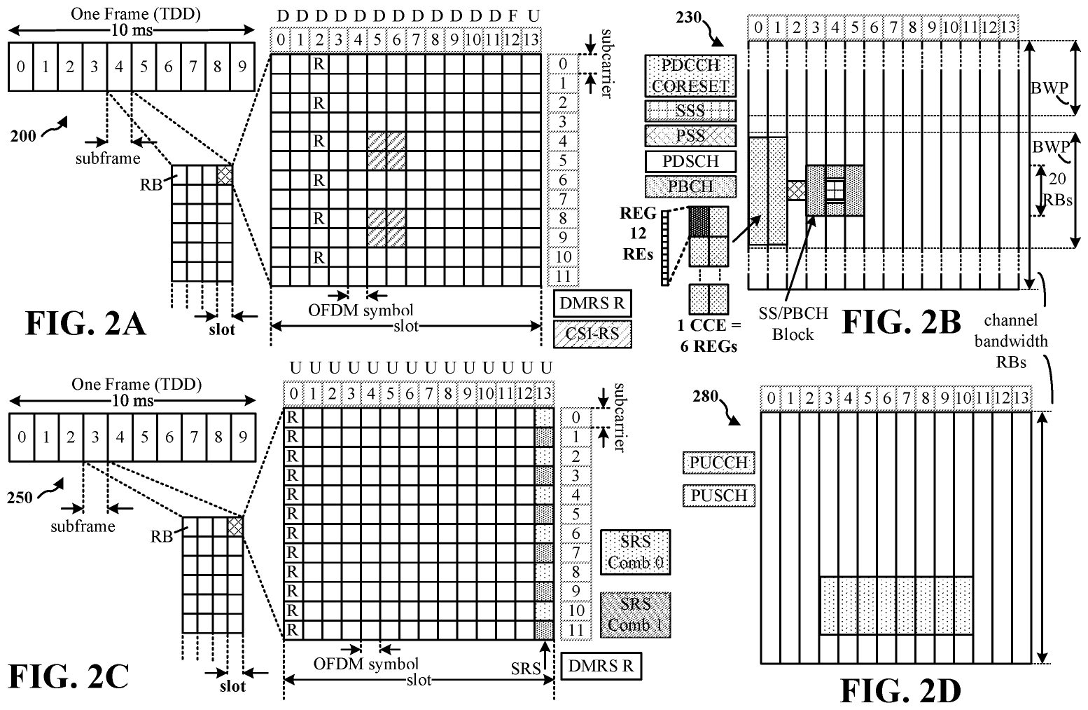

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies u 0 to 4 allow for 1, 2, 4, 8,and 16 slots, respectively, per subframe. For extended CP, the numerology 2 allows for 4 slots per subframe. Accordingly, for normal CP and numerology u, there are 14symbols/slot and 2″ slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

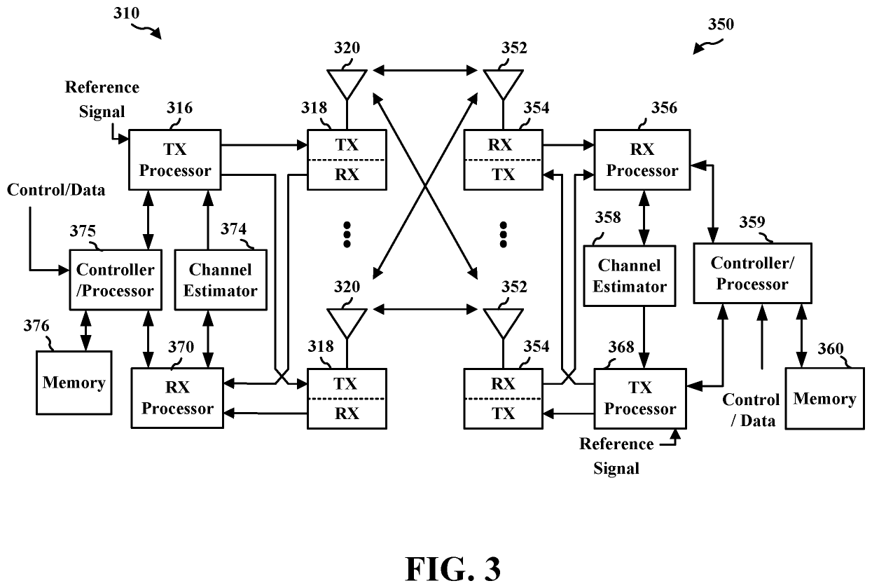

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with RIS configuration component 198 of FIG. 1.

At least one of the TX processor 316, the RX processor 370, and the controller/processor 375 may be configured to perform aspects in connection with RIS configuration component 199 of FIG. 1.

In wireless communication systems, MIMO may be used for increasing the throughput of a communication system. For example, high beamforming gain may be achieved by using active antenna units. Individual RF chains per antenna ports may be configured. Such usage of active antenna units, which may consume a lot of power, may result in a significantly increased power consumption in the wireless communication system.

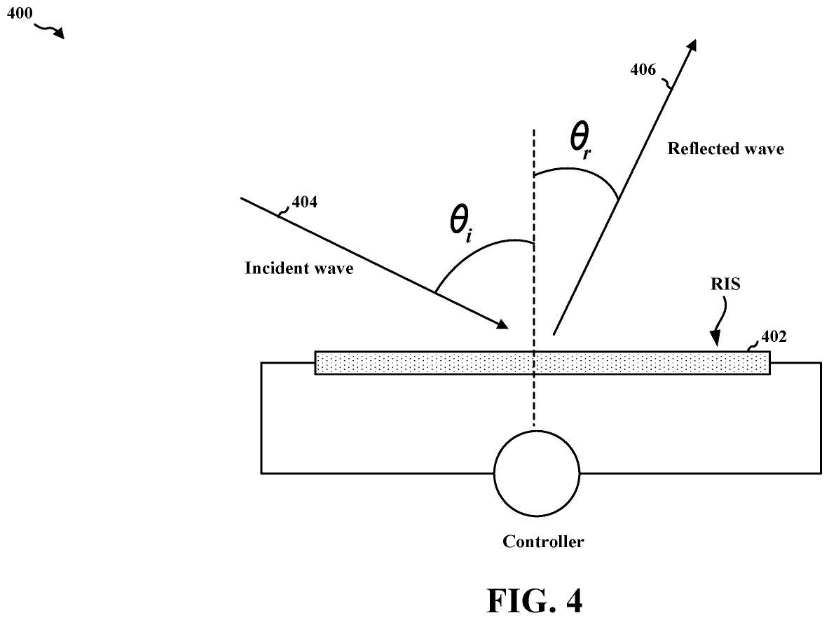

A RIS may be a two-dimensional surface of engineered material where the properties are reconfigurable rather than static. For example, the scattering, absorption, reflection, and diffraction properties may be configurable and controlled. RISs may be low-power passive devices without a transceiver that can act as a phased array. RISs may be used to steer an incident wave in the desired direction using a controller. For example, FIG. 4 is a diagram 400 illustrating an example RIS. As illustrated in FIG. 4, the RIS 402 may reflect an incident wave 404 into a reflected wave 406 in a particular direction. The angle at which the incident wave 404 arrives may be an angle of arrival (AoA). The reflection direction of the reflected wave 406 may be different based on different configurations of the RIS. The RIS's configuration may be controlled by another wireless device, such as a UE or a base station. Usage of a RIS may also change the channel environment. Because RISs may be low-power passive devices (or near passive devices), RISs may be deployed to extend coverage for wireless communication systems with negligible increased power consumption.

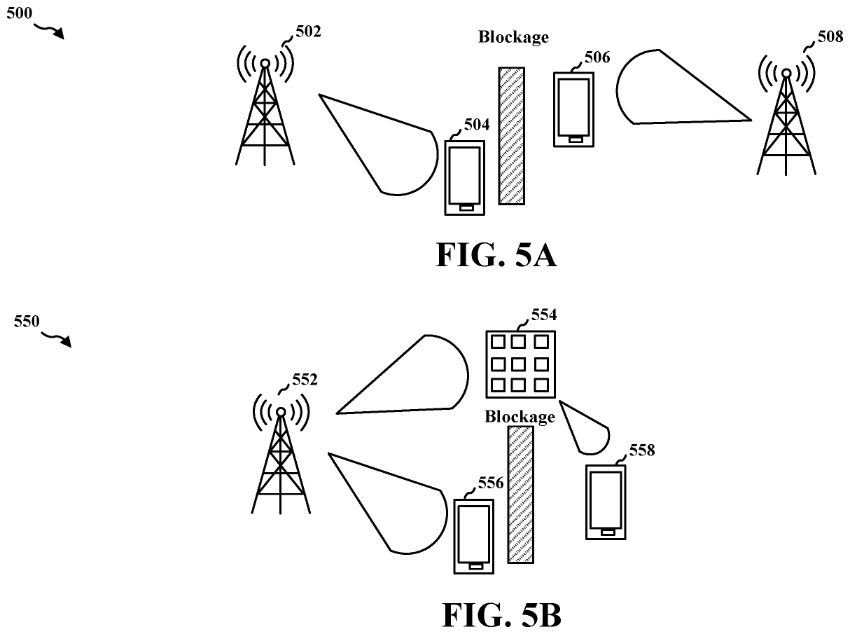

FIGS. 5A and 5B illustrate communications between UEs and base station(s) with and without a RIS. As illustrated in example 500 of FIG. 5A, a base station 502 of a wireless communication system may be in communication with a UE 504. The base station 502 may be unable to communicate with another UE 506 due to a blockage between the UE 506 and the base station 502 even if the UE 506 may be in range if there is no blockage. Therefore, in order for the wireless communication system to extend the coverage to cover the UE 506, a second base station 508 may be used. Compare example 500 of FIG. 5A to example 550 of FIG. 5B, where a base station 552 in FIG. 5B may be in communication with a UE 556 directly and also may be in communication with another UE 558 through a RIS 554. If there is no RIS 554, the base station 552 may be unable to establish communication with the UE 558 because of the blockage. By utilizing the reflection provided by the RIS 554, the base station 552 can extend coverage to be able to establish connection with the UE 558. Therefore, by using RIS, coverage of wireless communication systems may be enhanced or a same coverage can be achieved with less infrastructure and less power consumption.

Even though using RISs may enable enhanced coverage or more efficient power usage of wireless communication systems, the benefit of the RIS is dependent upon finding a good performing RIS configuration. As used herein, the term “RIS configuration” may refer to a RIS's surface configuration, which may be otherwise referred to as a “beamformer.” For example, the RIS configuration may be properties or parameters associated with each antenna in a dimensional array of antennas on a RIS. By way of example, an example configuration may include various parameters or properties such as electric and magnetic properties associated with each antenna in a dimensional array of antennas on a RIS. The configuration may affect a reflective angle, or other properties associated with a reflected wave reflected by the RIS. Finding a suitable or well performing RIS configuration may be important for realizing the potential advantages of using RISs in a wireless communication system. Aspects provided herein provide reinforcement learning based mechanisms and associated signaling for finding and configuring such RISs in order to use RISs more efficiently.

In a real-life environment, finding a suitable or well performing RIS configuration may be tricky because a first channel between the RIS and the transmitting wireless device and a second channel between the RIS and the receiving wireless device may be difficult to distinguish from the perspective of the transmitting wireless device or the receiving wireless device. Therefore, as the first channel or the second channel changes, it may be difficult to find a suitable or well performing RIS configuration. Aspects provided herein may use a Markov decision process (MDP) and convert the communication and the compound channel (considering the first and the second channel) into a state of the decision process, and find a suitable or well performing configuration for each state. Reinforcement learning methods may be used to find a suitable or well performing RIS's surface configuration.

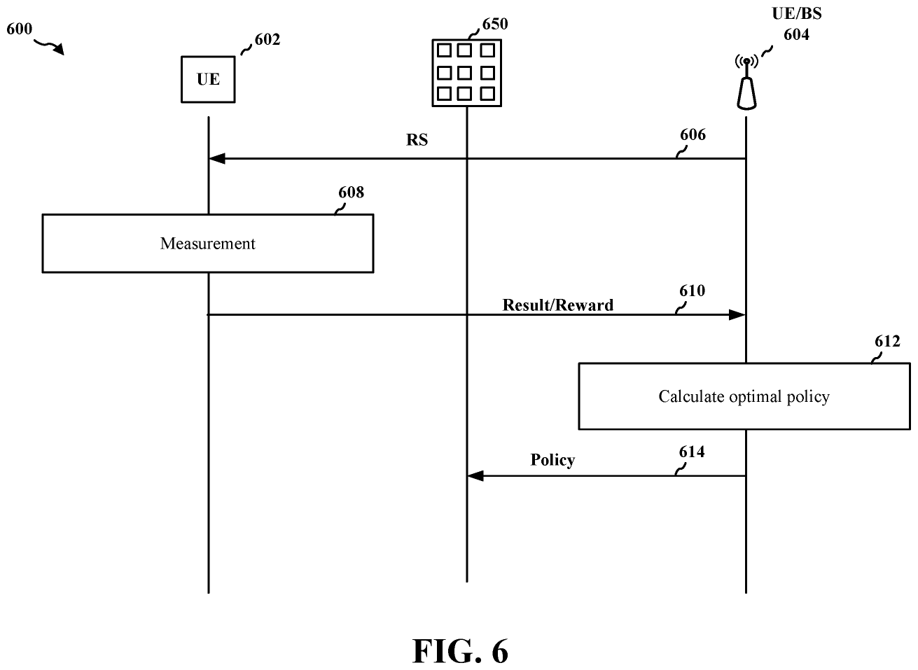

FIG. 6 is a diagram 600 illustrating an example communication flow between a UE 602, a base station/UE 604, and a RIS 650. As illustrated in FIG. 6, the base station/UE 604 may transmit a set of RSs 606 to the UE 602. By way of example, the set of RSs 606 may be transmitted to the UE 602 and received by the UE 602 through one or more of: a physical uplink control channel (PUCCH), a physical uplink shared channel (PUSCH), a physical sidelink control channel (PSCCH), a physical sidelink shared channel (PSSCH), or a physical sidelink feedback channel (PSFCH). For example, if the base station/UE 604 is a base station, a PUCCH, a PUSCH, or the like may be used. If the base station/UE 604 is a UE, a PSFCH, a PSCCH, or a PSSCH may be used. The set of RSs 606 may include K reference signals and may be used for training a mapping function. The base station/UE 604 may configure at least K single port resources, TDMed and QCLed, for the set of RSs 606. After receiving the set of RSs 606, the UE 602 may measure the set of RSs 606 at 608 and estimate HΦᵢG. For example, H may denote a first channel between the base station/UE 604 and the RIS 650, Φᵢ may denote i^{th} surface configuration of the RIS 650, and G may denote a second channel between the RIS 650 and the UE 602.

The UE 602 may also compute the state based on an agreed (between the UE 602, the base station/UE 604, and the RIS 650) mapping function F (HΦᵢG), where F () includes compression and quantization. In some aspects, the function may include cross-dimensional mapping, e.g., the mapping function may map a higher dimension with more parameters to a mapped result of less parameters. In some aspects, the function may be based on one or more of: one or more eigenvalues, a rank, a Doppler effect, or a delay spread. In some aspects, the UE 602 may also compute the result/reward 610. The result/reward 610 may be one or more parameters representing the received RS from the perspective of the UE 602, such as a reference signal received power (RSRP), a reference signal received quality (RSRQ), a signal-to-noise and interference ratio (SINR), an energy value, or the like. The UE 602 may transmit the result/reward 610 to the base station/UE 604. In some aspects, a PUCCH, a PUSCH, a PSCCH, a PSSCH, or a PSFCH may be used to transmit the result/reward 610 to the base station/UE 604. For example, if the base station/UE 604 is a base station, a PUCCH, a PUSCH, or the like may be used to transmit the result/reward 610. If the base station/UE 604 is a UE, a PSFCH, a PSCCH, or a PSSCH may be used to transmit the result/reward 610.

In some aspects, the UE 602 may sound all occasions based on the set of RSs 606 and the base station/UE 604 may accordingly estimate HΦᵢG. For example, H may denote a first channel between the base station/UE 604 and the RIS 650, Φᵢ may denote i^{th} surface configuration of the RIS 650, and G may denote a second channel between the RIS 650 and the UE 602.

In some aspects, the base station/UE 604 may also compute the state based on an agreed (between the UE 602, the base station/UE 604, and the RIS 650) mapping function F (HΦᵢG), where F( ) includes compression and quantization. In some aspects, the function may include cross-dimensional mapping, e.g., the mapping function may map a higher dimension with more parameters to a mapped result of less parameters. In some aspects, the function may be based on one or more of: one or more eigenvalues, a rank, a Doppler effect, or a delay spread. In some aspects, the base station/UE 604 may also compute the result/reward 610. The result/reward 610 may be one or more parameters representing the received RS from the perspective of the UE 602, such as an RSRP, an RSRQ, an SINR, an energy value, or the like. Because the base station/UE 604 may be aware of the action Φᵢ (where i={1, 2, . . . , L} with L denoting the number of codebook used for the M elements; the remaining are so far obtained from the linear mapping) (action corresponding to a configuration of the RIS 650), the base station/UE 604 may have information on {State, Action, Reward}. At a given time, state may be denoted by S(t)=F(HΦ(t)G) (the base station/UE 604 may quantize the elements and use that as state or use some of its characteristics such as eigenvalues, rank, Doppler, delay spread, or the like). The function F( ) may be a mapping from a higher dimension to a lower dimension and may include quantization. The action may be a(t)=Φᵢ. The reward may be R(t)=Rᵢ.

After obtaining the state and the reward, either from the UE 602 or based on its own calculation, the base station/UE 604 may calculate an optimal policy (configuration) at 612 and transmit an optimal configuration (policy 614) for each state, each state may be mapped to each RS of the set of RSs 606, to the RIS 650. For example, the base station/UE 604 may use a solver to find the optimal policy for each state. Alternatively, the UE 602 may calculate an optimal policy (configuration) at 612 and transmit an optimal configuration (policy 614) for each state, each state may be mapped to each RS of the set of RSs 606. Therefore, in a given time, a policy for a state may be transmitted to the RIS 650.

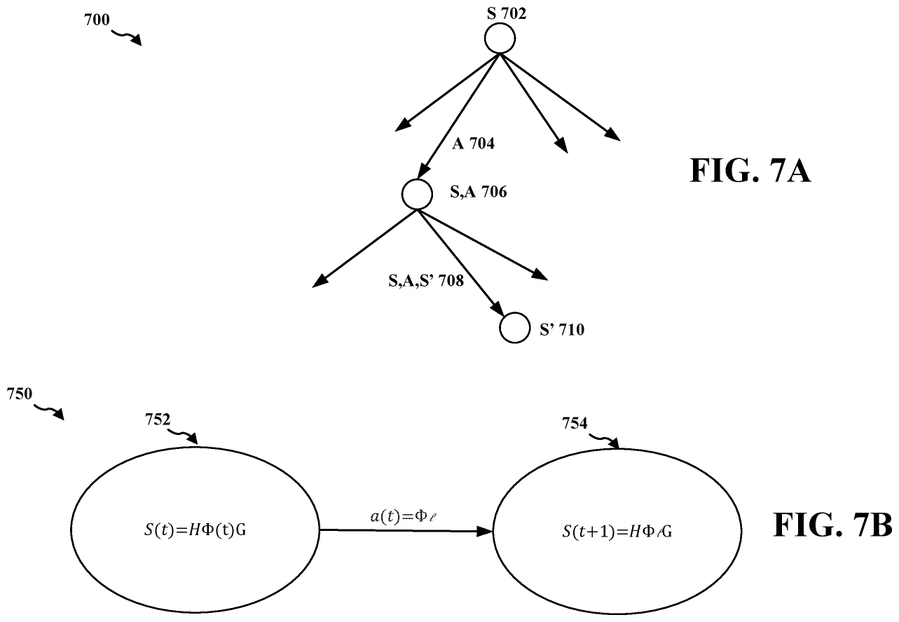

FIG. 7A is a diagram 700 illustrating an example MDP. An MDP may be a discrete-time stochastic control process and may provide a mathematical framework for modeling decision making in situation where outcomes are partly random and partly under control. In MDP, S may denote a set of states called the state space. In addition, A may denote a set of actions called the action space. After taking an action A 704, state S 702 may enter transitions which may be denoted by P (S′|S,A) where S′ 710 is new state, S is current state, and A is the current taken action. The rewards of the action may be rewards R (S,A,S′ 708) (and discount y). Discount y may represent a discount factor that decreases the reward. The reward may correspond with the result/reward 610 in FIG. 6 and may be one or more parameters representing the received RS from the perspective of the UE 602, such as an RSRP, an RSRQ, an SINR, or an energy value. In MDP, a finite number of states and actions may be assumed. In MDP, at each time the agent (e.g., the base station/UE 604) observes a state and an action, the incurred rewards may be maximized. The reward and the successor state may depend on the current state and the chosen action. Successor generation may be probabilistic, based on the uncertainty regarding the environment in which the search takes place. For example, an action might sometimes fail to result in the desired target state, instead staying in the current state with a small probability.

FIG. 7B is a diagram 750 illustrating an example state transition. As illustrated in FIG. 7B, at a time t, state 752 may be defined by HΦ(t) G. For example, H may denote a first channel between the base station/UE 604 and the RIS 650, Φ(t) may denote one surface configuration of the RIS 650 at the time t, and G may denote a second channel between the RIS 650 and the UE 602. When an action is taken to change the configuration to Φₗ, the next state, state 754 at time t+1, may become HΦ(t+1)G=HΦₗG.

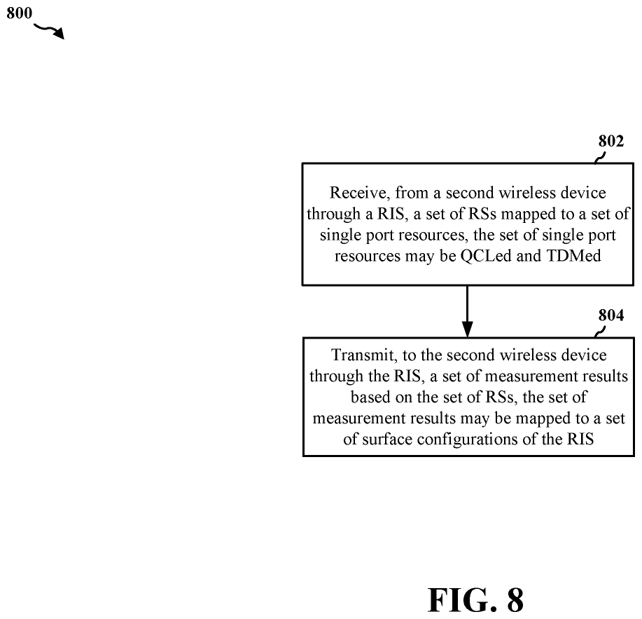

FIG. 8 is a flowchart 800 of a method of wireless communication. The method may be performed by a first wireless device, such as a UE (e.g., the UE 104, the UE 602; the apparatus 1202).

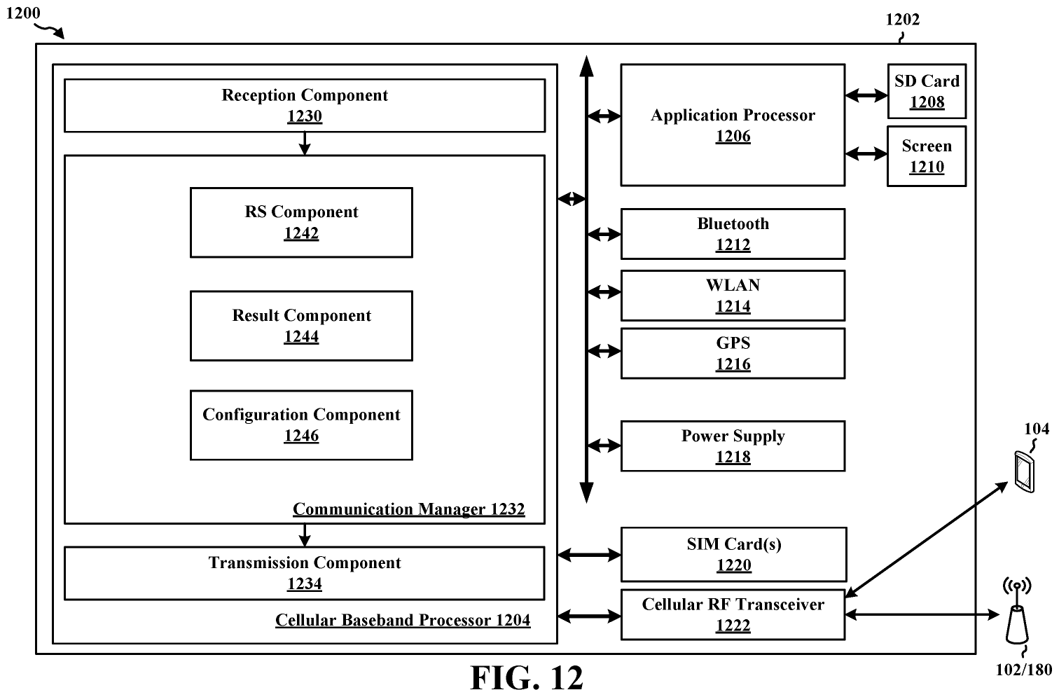

At 802, the first wireless device may receive, from a second wireless device through a RIS, a set of RSs mapped to a set of single port resources, the set of single port resources may be QCLed and TDMed. For example, the UE 602 may receive, from a second wireless device (e.g., base station/UE 604) through a RIS 650, a set of RSs 606 mapped to a set of single port resources, the set of single port resources may be QCLed and TDMed. In some aspects, 802 may be performed by RS component 1242 in FIG. 12.

At 804, the first wireless device may transmit, to the second wireless device through the RIS, a set of measurement results based on the set of RSs, the set of measurement results may be mapped to a set of surface configurations of the RIS. For example, the UE 602 may transmit, to the second wireless device through the RIS, a set of measurement results (e.g., result/reward 610) based on the set of RSs, the set of measurement results may be mapped to a set of surface configurations of the RIS. In some aspects, 804 may be performed by result component 1244 in FIG. 12.

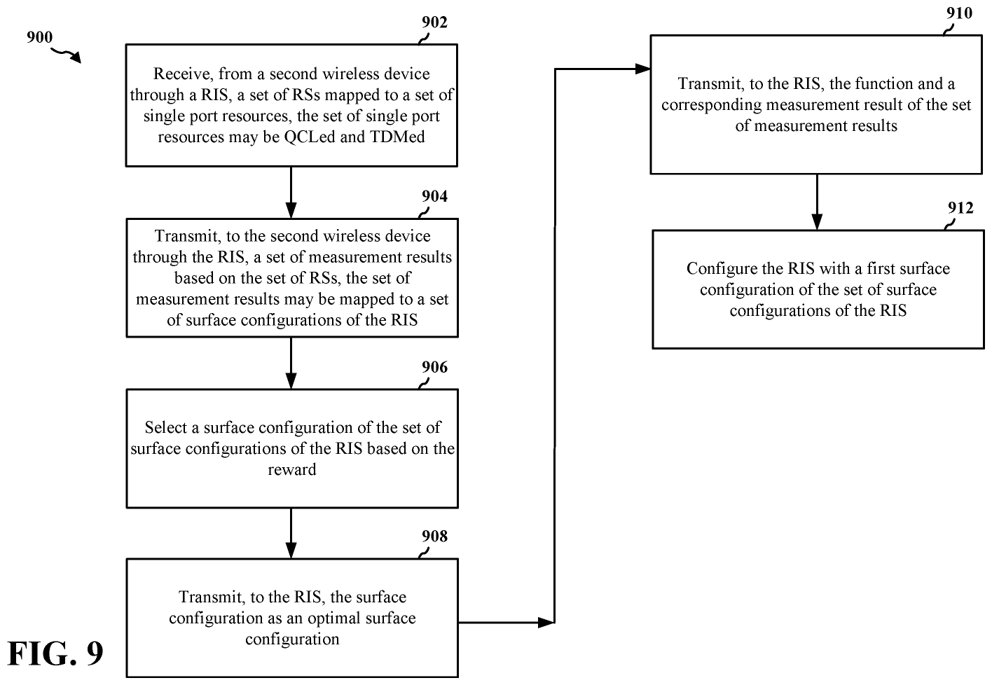

FIG. 9 is a flowchart 900 of a method of wireless communication. The method may be performed by a first wireless device, such as a UE (e.g., the UE 104, the UE 602; the apparatus 1202).

At 902, the first wireless device may receive, from a second wireless device through a RIS, a set of RSs mapped to a set of single port resources, the set of single port resources may be QCLed and TDMed. For example, the UE 602 may receive, from a second wireless device (e.g., base station/UE 604) through a RIS 650, a set of RSs 606 mapped to a set of single port resources, the set of single port resources may be QCLed and TDMed. In some aspects, 902 may be performed by RS component 1242 in FIG. 12.

At 904, the first wireless device may transmit, to the second wireless device through the RIS, a set of measurement results based on the set of RSs, the set of measurement results may be mapped to a set of surface configurations of the RIS. For example, the UE 602 may transmit, to the second wireless device through the RIS, a set of measurement results (e.g., result/reward 610) based on the set of RSs, the set of measurement results may be mapped to a set of surface configurations of the RIS. In some aspects, 904 may be performed by result component 1244 in FIG. 12.

In some aspects, the set of measurement results may be transmitted and received through one of: a PDCCH, a PDSCH, a PSCCH, a PSSCH, or a PSFCH. In some aspects, the first wireless device may be a first UE and the second wireless device may be a base station or a second UE.

In some aspects, each measurement result of the set of measurement results may be one or more of: an RSRP, an RSRQ, an SINR, or an energy value. In some aspects, the first wireless device may compute HΦᵢG corresponding to each measurement result of the set of measurement results, where H may denote a first channel between the second wireless device and the RIS, Φᵢ may denote one surface configuration of the RIS in the set of surface configurations, and G may denote a second channel between the RIS and the second wireless device. For example, the base station/UE 604 may compute HΦᵢG corresponding to each measurement result of the set of measurement results. In some aspects, each measurement result of the set of measurement results may correspond to a reward of a MDP. In some aspects, each surface configuration of the set of surface configurations of the RIS may correspond to an action of the MDP. The first wireless device may compute a function of the HΦᵢG corresponding to each measurement result, where the function of the HΦᵢG may correspond to a state of the MDP.

In some aspects, at 906, the first wireless device may select a surface configuration of the set of surface configurations of the RIS based on the reward. For example, the base station/UE 604 may select a surface configuration of the set of surface configurations of the RIS 650 based on the reward as part of 612. In some aspects, 906 may be performed by configuration component 1246.

In some aspects, at 908, the first wireless device may transmit, to the RIS, the surface configuration as an optimal surface configuration. For example, the base station/UE 604 may transmit, to the RIS 650, the surface configuration as an optimal surface configuration (e.g., policy 614). In some aspects, at 912, the first wireless device may also configure the RIS with a first surface configuration of the set of surface configurations of the RIS. In some aspects, 908 and 912 may be performed by configuration component 1246. In some aspects, at 910, the first wireless device may transmit, to the RIS, the function of the HΦᵢG and a corresponding measurement result of the set of measurement results. In some aspects, 910 may be performed by configuration component 1246. For example, the base station/UE 604 may transmit, to the RIS 650, the function of the HΦᵢG and a corresponding measurement result of the set of measurement results. In some aspects, the function may be based on one or more of: one or more eigenvalues, a rank, a Doppler effect, or a delay spread. In some aspects, the function may include cross-dimensional mapping. In some aspects, the function may include quantization. In some aspects, the function may include a compression.

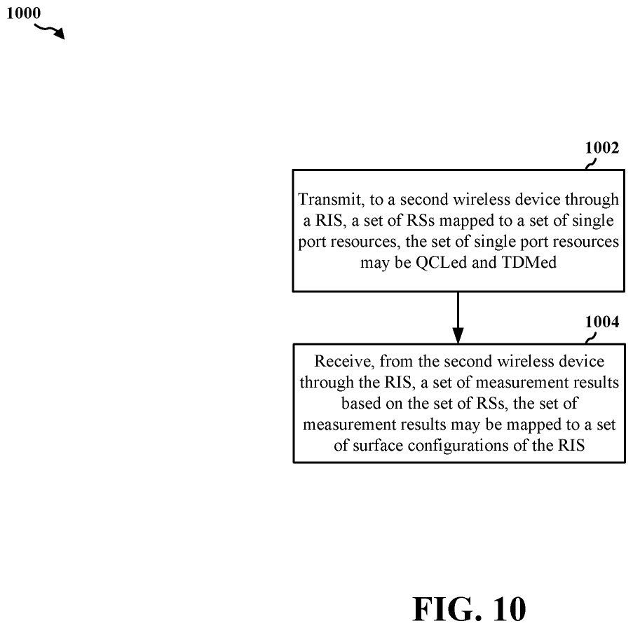

FIG. 10 is a flowchart 1000 of a method of wireless communication. The method may be performed by a first wireless device, such as a base station or a UE (e.g., the base station 102/180, the UE 104, the UE/base station 604; the apparatus 1302).

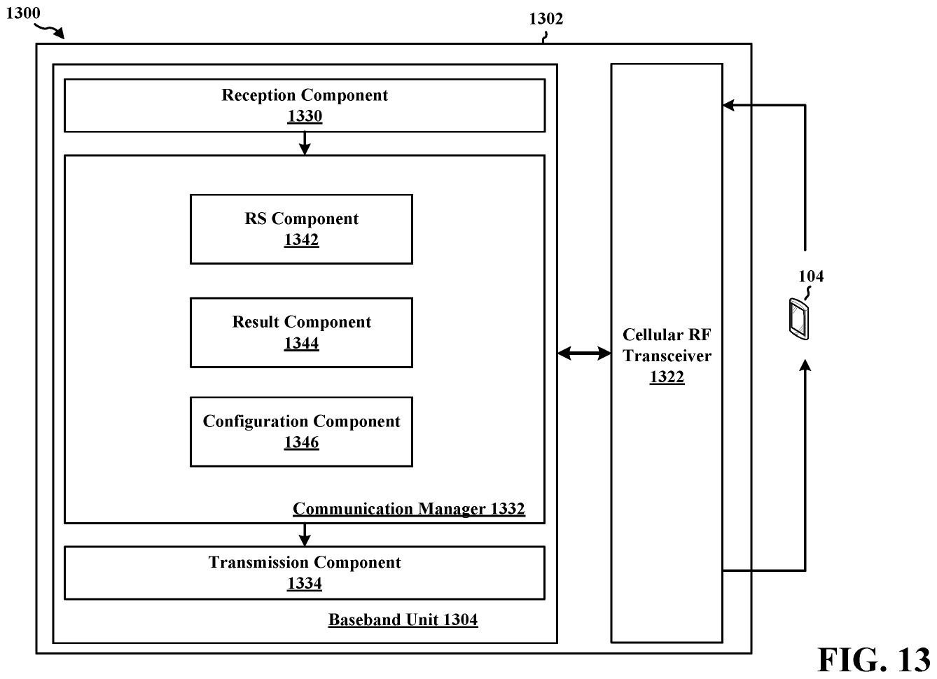

At 1002, the first wireless device may transmit, to a second wireless device through a RIS, a set of RSs mapped to a set of single port resources, the set of single port resources may be QCLed and TDMed. For example, the base station 604 may transmit, to a second wireless device (e.g., UE 602) through a RIS 650, a set of RSs 606 mapped to a set of single port resources, the set of single port resources may be QCLed and TDMed. In some aspects, 1002 may be performed by RS component 1342 in FIG. 13.

At 1004, the first wireless device may receive, from the second wireless device through the RIS, a set of measurement results based on the set of RSs, the set of measurement results may be mapped to a set of surface configurations of the RIS. For example, the base station 604 may receive, from the second wireless device through the RIS, a set of measurement results (e.g., result/reward 610) based on the set of RSs, the set of measurement results may be mapped to a set of surface configurations of the RIS. In some aspects, 1004 may be performed by result component 1344 in FIG. 13.

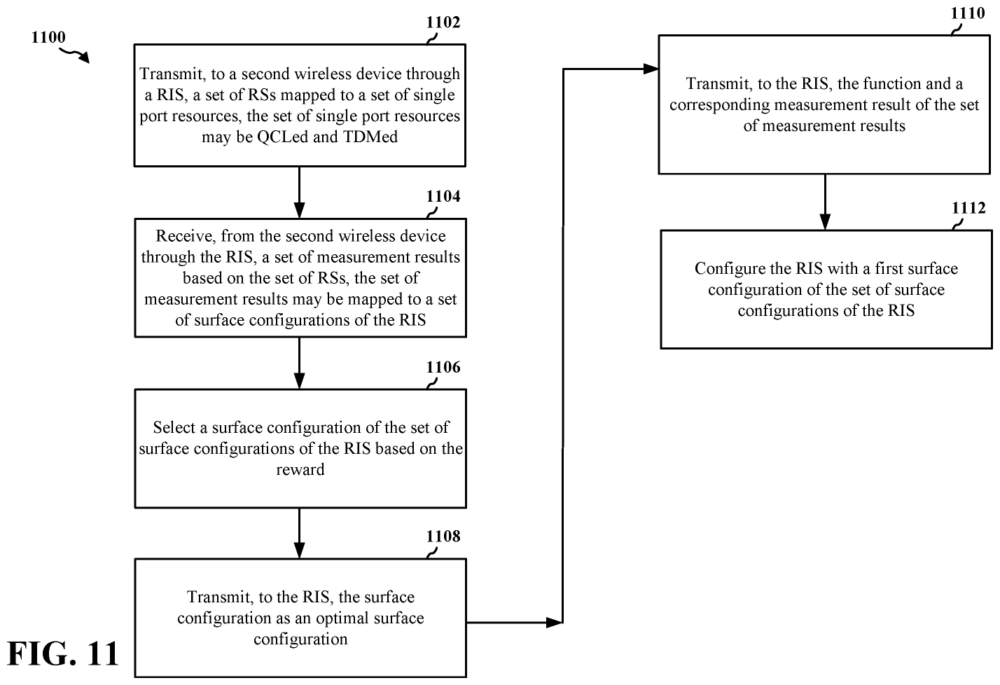

FIG. 11 is a flowchart 1100 of a method of wireless communication. The method may be performed by a first wireless device, such as a base station or a UE (e.g., the base station 102/180, the UE 104, the base station/UE 604; the apparatus 1302).

At 1102, the first wireless device may transmit, to a second wireless device through a RIS, a set of RSs mapped to a set of single port resources, the set of single port resources may be QCLed and TDMed. For example, the base station/UE 604 may transmit, to a second wireless device (e.g., UE 602) through a RIS 650, a set of RSs 606 mapped to a set of single port resources, the set of single port resources may be QCLed and TDMed. In some aspects, 1102 may be performed by RS component 1342 in FIG. 13.

At 1104, the first wireless device may receive, from the second wireless device through the RIS, a set of measurement results based on the set of RSs, the set of measurement results may be mapped to a set of surface configurations of the RIS. For example, the base station/UE 604 may receive, from the second wireless device through the RIS, a set of measurement results (e.g., result/reward 610) based on the set of RSs, the set of measurement results may be mapped to a set of surface configurations of the RIS. In some aspects, 1104 may be performed by result component 1344 in FIG. 13.

In some aspects, the set of measurement results may be transmitted and received through one of: a PDCCH, a PDSCH, a PSCCH, a PSSCH, or a PSFCH. In some aspects, the second wireless device may be a first UE and the first wireless device may be a base station or a second UE.

In some aspects, each measurement result of the set of measurement results may be one or more of: an RSRP, an RSRQ, an SINR, or an energy value. In some aspects, the first wireless device may compute HΦᵢG corresponding to each measurement result of the set of measurement results, where H may denote a first channel between the first wireless device and the RIS, Φᵢ may denote one surface configuration of the RIS in the set of surface configurations, and G may denote a second channel between the RIS and the second wireless device. For example, the base station/UE 604 may compute HΦᵢG corresponding to each measurement result of the set of measurement results. In some aspects, each measurement result of the set of measurement results may correspond to a reward of a MDP. In some aspects, each surface configuration of the set of surface configurations of the RIS may correspond to an action of the MDP. The first wireless device may compute a function of the HΦᵢG corresponding to each measurement result, where the function of the HΦᵢG may correspond to a state of the MDP.

In some aspects, at 1106, the first wireless device may select a surface configuration of the set of surface configurations of the RIS based on the reward. For example, the base station/UE 604 may select a surface configuration of the set of surface configurations of the RIS 650 based on the reward as part of 612. In some aspects, 1106 may be performed by configuration component 1346.

In some aspects, at 1108, the first wireless device may transmit, to the RIS, the surface configuration as an optimal surface configuration. For example, the base station/UE 604 may transmit, to the RIS 650, the surface configuration as an optimal surface configuration (e.g., policy 614). In some aspects, at 1112, the first wireless device may also configure the RIS with a first surface configuration of the set of surface configurations of the RIS. In some aspects, 1108 and 1112 may be performed by configuration component 1346. In some aspects, at 1110, the first wireless device may transmit, to the RIS, the function of the HΦᵢG and a corresponding measurement result of the set of measurement results. In some aspects, 1110 may be performed by configuration component 1346. For example, the base station/UE 604 may transmit, to the RIS 650, the function of the HΦᵢG and a corresponding measurement result of the set of measurement results. In some aspects, the function may be based on one or more of: one or more eigenvalues, a rank, a Doppler effect, or a delay spread. In some aspects, the function may include cross-dimensional mapping. In some aspects, the function may include quantization. In some aspects, the function may include a compression.

FIG. 12 is a diagram 1200 illustrating an example of a hardware implementation for an apparatus 1202. The apparatus 1202 may be a UE, a component of a UE, or may implement UE functionality. In some aspects, the apparatus 1202 may include a cellular baseband processor 1204 (also referred to as a modem) coupled to a cellular RF transceiver 1222. In some aspects, the apparatus 1202 may further include one or more subscriber identity modules (SIM) cards 1220, an application processor 1206 coupled to a secure digital (SD) card 1208 and a screen 1210, a Bluetooth module 1212, a wireless local area network (WLAN) module 1214, a Global Positioning System (GPS) module 1216, or a power supply 1218. The cellular baseband processor 1204 communicates through the cellular RF transceiver 1222 with the UE 104 and/or BS 102/180. The cellular baseband processor 1204 may include a computer-readable medium/memory. The computer-readable medium/memory may be non-transitory. The cellular baseband processor 1204 is responsible for general processing, including the execution of software stored on the computer-readable medium/memory. The software, when executed by the cellular baseband processor 1204, causes the cellular baseband processor 1204 to perform the various functions described supra. The computer-readable medium/memory may also be used for storing data that is manipulated by the cellular baseband processor 1204 when executing software. The cellular baseband processor 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the cellular baseband processor 1204. The cellular baseband processor 1204 may be a component of the UE 350 and may include the memory 360 and/or at least one of the TX processor 368, the RX processor 356, and the controller/processor 359. In one configuration, the apparatus 1202 may be a modem chip and include just the baseband processor 1204, and in another configuration, the apparatus 1202 may be the entire UE (e.g., sec 350 of FIG. 3) and include the additional modules of the apparatus 1202.

The communication manager 1232 may include an RS component 1242 that is configured to receive, from a second wireless device through a RIS, a set of RSs mapped to a set of single port resources, the set of single port resources may be QCLed and TDMed, e.g., as described in connection with 802 in FIG. 8, or 902 in FIG. 9. The communication manager 1232 may further include a result component 1244 that may be configured to transmit, to the second wireless device through the RIS, a set of measurement results based on the set of RSs, the set of measurement results may be mapped to a set of surface configurations of the RIS, e.g., as described in connection with 804 in FIG. 8, or 904 in FIG. 9. The communication manager 1232 may further include a configuration component 1246 that may be configured to select a surface configuration of the set of surface configurations of the RIS based on the reward, transmit, to the RIS, the surface configuration as an optimal surface configuration, transmit, to the RIS, the function of the HΦᵢG and a corresponding measurement result of the set of measurement results, or configure the RIS with a first surface configuration of the set of surface configurations of the RIS, e.g., as described in connection with 906, 908, 910, or 912 of FIG. 9.

The apparatus may include additional components that perform each of the blocks of the algorithm in the flowcharts of FIGS. 8-9. As such, each block in the flowcharts of FIGS. 8-9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1202 may include a variety of components configured for various functions. In one configuration, the apparatus 1202, and in particular the cellular baseband processor 1204, may include means for receiving, from a second wireless device through a RIS, a set of RSs mapped to a set of single port resources, the set of single port resources may be QCLed and TDMed. The cellular baseband processor 1204 may further include means for transmitting, to the second wireless device through the RIS, a set of measurement results based on the set of RSs, the set of measurement results may be mapped to a set of surface configurations of the RIS. The cellular baseband processor 1204 may further include means for computing HΦᵢG corresponding to each measurement result of the set of measurement results, where H may denote a first channel between the second wireless device and the RIS, Φᵢ may denote one surface configuration of the RIS in the set of surface configurations, and G may denote a second channel between the RIS and the first wireless device. The cellular baseband processor 1204 may further include means for computing a function of the HΦᵢG corresponding to each measurement result, where the function of the HΦᵢG may correspond to a state of the MDP. The cellular baseband processor 1204 may further include means for selecting a surface configuration of the set of surface configurations of the RIS based on the reward. The cellular baseband processor 1204 may further include means for transmitting, to the RIS, the surface configuration as an optimal surface configuration. The cellular baseband processor 1204 may further include means for transmitting, to the RIS, the function of the HΦᵢG and a corresponding measurement result of the set of measurement results. The cellular baseband processor 1204 may further include means for configuring the RIS with a first surface configuration of the set of surface configurations of the RIS. The means may be one or more of the components of the apparatus 1202 configured to perform the functions recited by the means. As described supra, the apparatus 1202 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 13 is a diagram 1300 illustrating an example of a hardware implementation for an apparatus 1302. The apparatus 1302 may be a base station, a component of a base station, or may implement base station functionality. In some aspects, the apparatus 1202 may include a baseband unit 1304. The baseband unit 1304 may communicate through a cellular RF transceiver 1322 with the UE 104. The baseband unit 1304 may include a computer-readable medium/memory. The baseband unit 1304 is responsible for general processing, including the execution of software stored on the computer-readable medium/memory. The software, when executed by the baseband unit 1304, causes the baseband unit 1304 to perform the various functions described supra. The computer-readable medium/memory may also be used for storing data that is manipulated by the baseband unit 1304 when executing software. The baseband unit 1304 further includes a reception component 1330, a communication manager 1332, and a transmission component 1334. The communication manager 1332 includes the one or more illustrated components. The components within the communication manager 1332 may be stored in the computer-readable medium/memory and/or configured as hardware within the baseband unit 1304. The baseband unit 1304 may be a component of the base station 310 and may include the memory 376 and/or at least one of the TX processor 316, the RX processor 370, and the controller/processor 375.

The communication manager 1332 may include an RS component 1342 that may be configured to transmit, to a second wireless device through a RIS, a set of RSs mapped to a set of single port resources, the set of single port resources may be QCLed and TDMed, e.g., as described in connection with 1002 in FIG. 10, or 1102 in FIG. 11. The communication manager 1332 further may include a result component 1344 that may be configured to receive, from the second wireless device through the RIS, a set of measurement results based on the set of RSs, the set of measurement results may be mapped to a set of surface configurations of the RIS, e.g., as described in connection with 1004 in FIG. 10, or 1104 in FIG. 11. The communication manager 1332 may further include a configuration component 1346 that may be configured to select a surface configuration of the set of surface configurations of the RIS based on the reward, transmit, to the RIS, the surface configuration as an optimal surface configuration, transmit, to the RIS, the function of the HΦᵢG and a corresponding measurement result of the set of measurement results, or configure the RIS with a first surface configuration of the set of surface configurations of the RIS, e.g., as described in connection with 1106, 1108, 1110, or 1112 of FIG. 11.

The apparatus may include additional components that perform each of the blocks of the algorithm in the flowcharts of FIGS. 10-11. As such, each block in the flowcharts of FIGS. 10-11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1302 may include a variety of components configured for various functions. In one configuration, the apparatus 1302, and in particular the baseband unit 1304, may include means for transmitting, to a second wireless device through a RIS, a set of RSs mapped to a set of single port resources, the set of single port resources may be QCLed and TDMed. The baseband unit 1304 may further include means for receiving, from the second wireless device through the RIS, a set of measurement results based on the set of RSs, the set of measurement results may be mapped to a set of surface configurations of the RIS. The baseband unit 1304 may further include means for computing HP¿G corresponding to each measurement result of the set of measurement results, where H may denote a first channel between the second wireless device and the RIS, Pi may denote one surface configuration of the RIS in the set of surface configurations, and G may denote a second channel between the RIS and the first wireless device. The baseband unit 1304 may further include means for computing a function of the HΦᵢG corresponding to each measurement result, where the function of the HΦᵢG may correspond to a state of the MDP. The baseband unit 1304 may further include means for selecting a surface configuration of the set of surface configurations of the RIS based on the reward. The baseband unit 1304 may further include means for transmitting, to the RIS, the surface configuration as an optimal surface configuration. The baseband unit 1304 may further include means for transmitting, to the RIS, the function of the HΦᵢG and a corresponding measurement result of the set of measurement results. The baseband unit 1304 may further include means for configuring the RIS with a first surface configuration of the set of surface configurations of the RIS. The means may be one or more of the components of the apparatus 1302 configured to perform the functions recited by the means. As described supra, the apparatus 1302 may include the TX Processor 316, the RX Processor 370, and the controller/processor 375. As such, in one configuration, the means may be the TX Processor 316, the RX Processor 370, and the controller/processor 375 configured to perform the functions recited by the means.

By using RISs, coverage of wireless communication systems may be enhanced or a same coverage can be achieved with less infrastructure and less power consumption. Aspects provided herein provide reinforcement learning based mechanisms and associated signaling for finding and configuring such RISs to use RISs more efficiently.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a first wireless device, comprising: a memory; and at least one processor coupled to the memory and configured to, based at least in part on information stored in the memory: receive, from a second wireless device through a RIS, a set of RSs mapped to a set of single port resources, the set of single port resources being QCLed and TDMed; and transmit, to the second wireless device through the RIS, a set of measurement results based on the set of RSs, the set of measurement results being mapped to a set of surface configurations of the RIS.

Aspect 2 is the apparatus of aspect 1, wherein each measurement result of the set of measurement results is one or more of: a RSRP, a RSRQ, a SINR, or an energy value.

Aspect 3 is the apparatus of any of aspects 1-2, wherein the at least one processor is further configured to: compute HΦᵢG corresponding to each measurement result of the set of measurement results, wherein H denotes a first channel between the second wireless device and the RIS, Φᵢ denotes one surface configuration of the RIS in the set of surface configurations, and G denotes a second channel between the RIS and the first wireless device.

Aspect 4 is the apparatus of any of aspects 1-3, wherein each measurement result of the set of measurement results corresponds to a reward of a MDP, wherein each surface configuration of the set of surface configurations of the RIS corresponds to an action of the MDP, and wherein the at least one processor is further configured to: compute a function of the HΦᵢG corresponding to each measurement result, wherein the function of the HΦᵢG corresponds to a state of the MDP.

Aspect 5 is the apparatus of any of aspects 1-4, wherein the at least one processor is further configured to: select a surface configuration of the set of surface configurations of the RIS based on the reward; and transmit, to the RIS, the surface configuration as an optimal surface configuration.

Aspect 6 is the apparatus of any of aspects 1-5, wherein the at least one processor is further configured to: transmit, to the RIS, the function of the HΦᵢG and a corresponding measurement result of the set of measurement results.

Aspect 7 is the apparatus of any of aspects 1-6, wherein the function is based on one or more of: one or more eigenvalues, a rank, a Doppler effect, or a delay spread.

Aspect 8 is the apparatus of any of aspects 1-7, wherein the function comprises cross-dimensional mapping.

Aspect 9 is the apparatus of any of aspects 1-8, wherein the function comprises quantization.

Aspect 10 is the apparatus of any of aspects 1-9, wherein the function comprises a compression.

Aspect 11 is the apparatus of any of aspects 1-10, wherein the at least one processor is further configured to: configure the RIS with a first surface configuration of the set of surface configurations of the RIS.

Aspect 12 is the apparatus of any of aspects 1-11, wherein the set of measurement results is transmitted through one of: a PDCCH, a PDSCH, a PSCCH, a PSSCH, or a PSFCH.

Aspect 13 is the apparatus of any of aspects 1-12, wherein the first wireless device is a first UE and the second wireless device is a base station or a second UE.

Aspect 14 is the apparatus of any of aspects 1-13, further comprising a transceiver coupled to the at least one processor.

Aspect 15 is an apparatus for wireless communication at a first wireless device, comprising: a memory; and at least one processor coupled to the memory and configured to, based at least in part on information stored in the memory: transmit, to a second wireless device through a RIS, a set of RSs mapped to a set of single port resources, the set of single port resources being QCLed and TDMed; and receive, from the second wireless device through the RIS, a set of measurement results based on the set of RSs, the set of measurement results being mapped to a set of surface configurations of the RIS.

Aspect 16 is the apparatus of aspect 15, wherein each measurement result of the set of measurement results is one or more of: a RSRP, a RSRQ, a SINR, or an energy value.

Aspect 17 is the apparatus of any of aspects 15-16, wherein the at least one processor is further configured to: compute HΦᵢG corresponding to each measurement result of the set of measurement results, wherein H denotes a first channel between the first wireless device and the RIS, Φᵢ denotes one surface configuration of the RIS in the set of surface configurations, and G denotes a second channel between the RIS and the second wireless device.

Aspect 18 is the apparatus of any of aspects 15-17, wherein each measurement result of the set of measurement results corresponds to a reward of a MDP, wherein each surface configuration of the set of surface configurations of the RIS corresponds to an action of the MDP, and wherein the at least one processor is further configured to: compute a function of the HΦᵢG corresponding to each measurement result, wherein the function of the HΦᵢG corresponds to a state of the MDP.

Aspect 19 is the apparatus of any of aspects 15-18, wherein the at least one processor is further configured to: select a surface configuration of the set of surface configurations of the RIS based on the reward; and transmit, to the RIS, the surface configuration as an optimal surface configuration.

Aspect 20 is the apparatus of any of aspects 15-19, wherein the at least one processor is further configured to: transmit, to the RIS, the function of the HΦᵢG and a corresponding measurement result of the set of measurement results.

Aspect 21 is the apparatus of any of aspects 15-20, wherein the function is based on one or more of: one or more eigenvalues, a rank, a Doppler effect, or a delay spread.

Aspect 22 is the apparatus of any of aspects 15-21, wherein the function comprises cross-dimensional mapping.

Aspect 23 is the apparatus of any of aspects 15-22, wherein the function comprises quantization.

Aspect 24 is the apparatus of any of aspects 15-23, wherein the function comprises a compression.

Aspect 25 is the apparatus of any of aspects 15-24, wherein the at least one processor is further configured to: configure the RIS with a first surface configuration of the set of surface configurations of the RIS.

Aspect 26 is the apparatus of any of aspects 15-25, wherein the set of measurement results is received through one of: a PDCCH, a PDSCH, a PSCCH, a PSSCH, or a PSFCH.

Aspect 27 is the apparatus of any of aspects 15-26, wherein the second wireless device is a first UE and the first wireless device is a base station or a second UE.

Aspect 28 is the apparatus of any of aspects 15-27, further comprising a transceiver coupled to the at least one processor.

Aspect 29 is a method of wireless communication for implementing any of aspects 1 to 14.

Aspect 30 is an apparatus for wireless communication including means for implementing any of aspects 1 to 14.

Aspect 31 is a computer-readable medium storing computer executable code, where the code when executed by a processor causes the processor to implement any of aspects 1 to 14.

Aspect 32 is a method of wireless communication for implementing any of aspects 15 to 28.

Aspect 33 is an apparatus for wireless communication including means for implementing any of aspects 15 to 28.

Aspect 34 is a computer-readable medium storing computer executable code, where the code when executed by a processor causes the processor to implement any of aspects 15 to 28.

What is claimed is:

1. An apparatus for wireless communication at a first wireless device, comprising:
a memory; and
at least one processor coupled to the memory and configured to, based at least in part on information stored in the memory:
receive, from a second wireless device through a reconfigurable intelligent surface (RIS), a set of reference signals (RSs) mapped to a set of single port resources, the set of single port resources being quasi-co-located (QCLed) and time division multiplexed (TDMed); and
transmit, to the second wireless device through the RIS, a set of measurement results based on the set of RSs, the set of measurement results being mapped to a set of surface configurations of the RIS.

2. The apparatus of claim 1, wherein each measurement result of the set of measurement results is one or more of: a reference signal received power (RSRP), a reference signal received quality (RSRQ), a signal-to-noise and interference ratio (SINR), or an energy value.

3. The apparatus of claim 1, wherein the at least one processor is further configured to:
compute H
corresponding to each measurement result of the set of measurement results, wherein H denotes a first channel between the second wireless device and the RIS, Φᵢ denotes one surface configuration of the RIS in the set of surface configurations, and G denotes a second channel between the RIS and the first wireless device.

4. The apparatus of claim 3, wherein each measurement result of the set of measurement results corresponds to a reward of a Markov decision process (MDP), wherein each surface configuration of the set of surface configurations of the RIS corresponds to an action of the MDP, and wherein the at least one processor is further configured to:
compute a function of the HΦ₁G corresponding to each measurement result, wherein the function of the HΦ₁G corresponds to a state of the MDP.

5. The apparatus of claim 4, wherein the at least one processor is further configured to:
select a surface configuration of the set of surface configurations of the RIS based on the reward; and
transmit, to the RIS, the surface configuration as an optimal surface configuration.

6. The apparatus of claim 4, wherein the at least one processor is further configured to:
transmit, to the RIS, the function of the HΦ₁G and a corresponding measurement result of the set of measurement results.

7. The apparatus of claim 4, wherein the function is based on one or more of: one or more eigenvalues, a rank, a Doppler effect, or a delay spread.

8. The apparatus of claim 4, wherein the function comprises cross-dimensional mapping.

9. The apparatus of claim 4, wherein the function comprises quantization.

10. The apparatus of claim 4, wherein the function comprises a compression.

11. The apparatus of claim 4, wherein the at least one processor is further configured to:
configure the RIS with a first surface configuration of the set of surface configurations of the RIS.

12. The apparatus of claim 4, wherein the set of measurement results is transmitted through one of: a physical downlink control channel (PDCCH), a physical downlink shared channel (PDSCH), a physical sidelink control channel (PSCCH), a physical sidelink shared channel (PSSCH), or a physical sidelink feedback channel (PSFCH).

13. The apparatus of claim 1, wherein the first wireless device is a first user equipment (UE) and the second wireless device is a base station or a second UE.

14. The apparatus of claim 1, further comprising a transceiver coupled to the at least one processor.

15. An apparatus for wireless communication at a first wireless device, comprising:
a memory; and
at least one processor coupled to the memory and configured to, based at least in part on information stored in the memory:
transmit, to a second wireless device through a reconfigurable intelligent surface (RIS), a set of reference signals (RSs) mapped to a set of single port resources, the set of single port resources being quasi-co-located (QCLed) and time division multiplexed (TDMed); and
receive, from the second wireless device through the RIS, a set of measurement results based on the set of RSs, the set of measurement results being mapped to a set of surface configurations of the RIS.

16. The apparatus of claim 15, wherein each measurement result of the set of measurement results is one or more of: a reference signal received power (RSRP), a reference signal received quality (RSRQ), a signal-to-noise and interference ratio (SINR), or an energy value.

17. The apparatus of claim 15, wherein the at least one processor is further configured to:
compute HΦ₁G corresponding to each measurement result of the set of measurement results, wherein H denotes a first channel between the first wireless device and the RIS, Φ₁ denotes one surface configuration of the RIS in the set of surface configurations, and G denotes a second channel between the RIS and the second wireless device.

18. The apparatus of claim 17, wherein each measurement result of the set of measurement results corresponds to a reward of a Markov decision process (MDP), wherein each surface configuration of the set of surface configurations of the RIS corresponds to an action of the MDP, and wherein the at least one processor is further configured to:
compute a function of the HΦ₁G corresponding to each measurement result, wherein the function of the HΦ₁G corresponds to a state of the MDP.

19. The apparatus of claim 18, wherein the at least one processor is further configured to:
select a surface configuration of the set of surface configurations of the RIS based on the reward; and
transmit, to the RIS, the surface configuration as an optimal surface configuration.

20. The apparatus of claim 18, wherein the at least one processor is further configured to:
transmit, to the RIS, the function of the HΦ₁G and a corresponding measurement result of the set of measurement results.

21. The apparatus of claim 18, wherein the function is based on one or more of: one or more eigenvalues, a rank, a Doppler effect, or a delay spread.

22. The apparatus of claim 18, wherein the function comprises cross-dimensional mapping.

23. The apparatus of claim 18, wherein the function comprises quantization.

24. The apparatus of claim 18, wherein the function comprises a compression.

25. The apparatus of claim 18, wherein the at least one processor is further configured to:
configure the RIS with a first surface configuration of the set of surface configurations of the RIS.

26. The apparatus of claim 18, wherein the set of measurement results is received through one of: a physical downlink control channel (PDCCH), a physical downlink shared channel (PDSCH), a physical sidelink control channel (PSCCH), a physical sidelink shared channel (PSSCH), or a physical sidelink feedback channel (PSFCH).

27. The apparatus of claim 15, wherein the second wireless device is a first user equipment (UE) and the first wireless device is a base station or a second UE.

28. The apparatus of claim 15, further comprising a transceiver coupled to the at least one processor.

29. A method for wireless communication at a first wireless device, comprising:
receiving, from a second wireless device through a reconfigurable intelligent surface (RIS), a set of reference signals (RSs) mapped to a set of single port resources, the set of single port resources being quasi-co-located (QCLed) and time division multiplexed (TDMed); and
transmitting, to the second wireless device through the RIS, a set of measurement results based on the set of RSs, the set of measurement results being mapped to a set of surface configurations of the RIS.

30. A method for wireless communication at a first wireless device, comprising:
transmitting, to a second wireless device through a reconfigurable intelligent surface (RIS), a set of reference signals (RSs) mapped to a set of single port resources, the set of single port resources being quasi-co-located (QCLed) and time division multiplexed (TDMed); and
receiving, from the second wireless device through the RIS, a set of measurement results based on the set of RSs, the set of measurement results being mapped to a set of surface configurations of the RIS.
